(19) United States
(12) Patent Application Publication
(10) Pub. No.: US 2022/0041205 A1
(43) Pub. Date: Feb. 10, 2022

(54) Method for Preparing a Steering Gear for Subsequent Use, and Steering Gear

(71) Applicant: Robert Bosch GmbH, Stuttgart (DE)

(72) Inventors: Martin Zimmermann, Schwaebisch Gmuend (DE); Jens-Uwe Hafermalz, Waeschenbeuren (DE); Dennis Fuechsel, Schwaebisch Gmuend (DE)

(21) Appl. No.: 17/278,899

(22) PCT Filed: Sep. 11, 2019
(86) PCT No.: PCT/EP2019/074288

§ 371 Date: Mar. 23, 2021

(30) Foreign Application Priority Data
Oct. 12, 2018 (DE) 10 2018 217 460.1

(51) Int. Cl. B62D 5/04

(52) U.S. Cl. CPC B62D 5/0454; B62D 5/0403

(57) ABSTRACT

A method is disclosed for preparing a steering gear for subsequent use as part of a steering system of a motor vehicle, the steering gear includes at least a gear and a pinion meshing with the gear, and at least the teeth of the gear and/or of the pinion being made of plastic. The pinion is first pressed against the gear by way of a first force, while at the same time the pinion and the gear are rotated first in a first direction of rotation and subsequently in the second direction of rotation. The first force is preferably selected so high that plastic deformation of the plastic of the pinion and/or of the gear is achieved. Subsequently, the pinion is pressed against the gear by way of a second, defined force, which is less than the first force, the second force being permanently set.

The invention relates to a method for preparing a steering gear mechanism for subsequent use as part of a steering system of a motor vehicle. The steering system may in particular be a power-assisted steering system. The invention also relates to a steering gear mechanism which is advantageously suitable for carrying out such a method.

In most motor vehicles, power-assisted steering systems which during steering produce a supporting torque and thereby reduce the torque which has to be applied to the steering column by the driver are installed.

The known power-assisted steering systems are based on a steering gear mechanism which translates the drive power of a hydraulic or electric steering motor and which, for example, transmits it to the steering column. Such steering gear mechanisms are generally constructed in the form of a screw rolling gear mechanism and in particular as a helical gear mechanism or as a worm gear mechanism. These gear mechanisms comprise a gear which is directly or indirectly connected to the steering column and a pinion which meshes therewith and which is driven by the steering motor via a shaft.

A problem with such steering gear mechanisms has been found to be gear play which, as a result of component tolerances, forms different thermal expansions of the gear mechanism elements, as a result of wear and/or as a result of settlement of the material in gears of plastics material. In particular with a so-called alternating steering action, that is to say, with a directly successive steering action with an alternating steering angle direction, such a gear play produces undesirable noises, which result from the alternating application against opposing flanks of the teeth of the pinion and gear.

It is known to eliminate this gear play by the pinion shaft being pivotably supported about an axis which extends perpendicularly to the longitudinal axis of the pinion shaft and with spacing from the tooth engagement of the pinion and gear and being pressed by means of one or more resilient elements against the gear. The pivotability of the pinion shaft is in this instance generally integrated in one of the two bearings via which the pinion shaft is supported at the end side. This bearing is referred to as a fixed bearing. The bearing in the region of the other end is then. configured with a defined movability (so-called movable bearing) in order to enable the deflection which is involved with such a pivoting movement. The fixed bearing may in particular be provided at the drive side, whilst the movable bearing is provided at the free end of the pinion shaft. The resilient element(s) for pressing the pinion against the gear may in this instance be integrated both in the movable bearing and in the fixed bearing.

Such a steering gear mechanism, in which the resilient force for the resilient application is produced by means of the fixed bearing, is known, for example, from EP 2 513 503 B1. A steering gear mechanism in which the resilient force for the resilient application is produced in contrast in the region of the movable bearing is known, for example, from DE 10 2008 001 878 A1.

The problem with such a steering gear mechanism may in particular be the adjustment of the most optimum possible resilient application. In order to achieve adequate resilient application and consequently the most advantageous possible noise behavior even after a relatively long period of use of such a steering gear mechanism and consequently after a settlement of the plastics material or the plastics materials from which the pinion and/or the gear is/are formed, and after wear of these components which has taken place to the relevant extent, the intensity of the resilient application in the new state should be selected to be relatively large which, however, at times, that is to say, in the new state, leads to a relatively large friction in the tooth engagement and consequently to a disadvantageous steering sensation. In contrast, a resilient application of the pinion shaft which is optimized with respect to the friction in the tooth engagement and consequently with respect to the steering sensation in the new state may lead to a small resilient application and consequently to disadvantageous noise behavior of the steering gear mechanism after a relatively long period of use.

An object of the invention was to minimize this configuration contradiction in the construction of a steering gear mechanism.

This object is achieved by means of a method for preparing a steering gear mechanism for subsequent use according to patent claim 1. A steering gear mechanism which is advantageously suitable for carrying out such a method is the subject-matter of patent claim 7. Preferred embodiments of the method according to the invention and advantageous embodiments of the steering gear mechanism according to the invention are the subject-matter of the additional patent claims and/or are derived from the following description of the invention.

According to the invention, a method which has to be carried out during the production of a steering gear mechanism for preparing this steering gear mechanism for subsequent use as part of a steering system of a motor o vehicle is provided. The steering gear mechanism has to this end at least one gear and a pinion which meshes with the gear. In this instance, at least the teeth of the gear and/or of the pinion are formed from plastics material (that is to say, at least partially from a plastics material or a plurality of plastics materials). According to the invention, there is provision in this instance for the pinion to initially be pressed with a first defined force against the gear, wherein at the same time the pinion and the gear are first rotated in a first rotation direction and subsequently in the second rotation direction. Preferably in this instance, the first force is selected to be so high that a plastic deformation of the plastics material of the pinion and/or of the gear is achieved. Subsequently, the pinion is pressed with a second, defined force which is smaller than the first force against the gear, wherein this second force is permanently adjusted or maintained, that is to say, at least for the subsequent beginning of the use of the steering gear mechanism as part of the steering system.

As a result of this preparation of the steering gear mechanism according to the invention, it may be possible for the plastics material or the plastics materials from which the pinion and/or the gear is/are produced to become plastically deformed even before the start of the actual operation of the steering gear mechanism. A settlement of the plastics material or the plastics materials is consequently brought about in a deliberate and accelerated form before the start of the use of the steering gear mechanism. Such settlement processes during the actual operation of the steering gear mechanism in which the pinion is still pressed against the gear only with a relatively small (second) force which is configured with a view to the most optimum possible steering sensation thereby do not occur or occur only to a relatively small extent. At the same time, tolerance-related deviations to the structurally configured tooth engagement between the pinion and gear are thereby compensated for, which can be attributed not only to a plastic deformation of the plastics material(s) but also to the relatively high level of friction in the tooth engagement during rotational movements of the pinion and the gear under the influence of the first force. Accordingly, the method according to the invention can also advantageously be carried out when the first force is not selected to be so high that a plastic deformation of the plastics material(s) is brought about.

As a result of the preparation of the steering gear mechanism provided for according to the invention for subsequent operation, a change of the level of force with which the pinion is pressed against the gear during use of the steering gear mechanism is minimized over the period of use of the steering gear mechanism. The most optimum possible steering sensation and the most advantageous or low noise behavior possible over the entire period of use of the steering gear mechanism are thereby brought about.

According to a preferred embodiment of a method according to the invention, there may be provision for the pinion and the gear to be rotated in the first rotation direction and/or in the second rotation direction until the gear has carried out (in each case) at least one complete revolution. It can thereby be ensured that all the teeth of the gear produced from plastics material are prepared for subsequent use as a result of the relatively large loading resulting from the pressing of the pinion by means of the relatively large first force.

According to another preferred embodiment of a method according to the invention, there may additionally be provision for at least the gear and/or the pinion to be subjected at least temporarily during the pressing of the pinion with the first force to an atmosphere which differs from the normal ambient atmosphere or the ambient climate. Factors for influencing this atmosphere are in this instance in particular the composition, the temperature and the moisture or water content, wherein these factors can be influenced in any number and combination. For example, as a result of the adjustment of a relatively high atmospheric temperature, a correspondingly high body temperature of the gear and/or the pinion can be achieved, whereby, on the one hand, the specific plastic deformability of the plastics material(s) can be increased and, as a result of thermally produced expansions of these components, the pressing pressure in the tooth engagement can be increased.

Furthermore, there may be provision for a contact means which influences the friction in the tooth engagement to be introduced into the tooth engagement of the pinion and gear at least during the pressing of the pinion with the first force. In this instance, there may be provision for the friction in the tooth engagement to be both deliberately increased and decreased by the contact means. The former situation may lead to an intentionally increased wear during the preparation, whilst the second alternative can be used to press the pinion shaft with a particularly high first force against the gear. The contact means may in spite of this relatively high first force enable a rotation of the pinion and the gear in both rotation directions without such a large torque which could lead to damage of components of the steering gear mechanism having to be applied to this end to the and/or the gear.

A steering gear mechanism which is advantageously suitable for carrying out a method according to the invention for a steering system of a motor vehicle comprises at least a housing, a gear, a pinion which meshes with the gear, in particular a helical pinion, and a pinion shaft which comprises the pinion, wherein at least the teeth of the gear and/or the pinion are formed from plastics material. Furthermore, the pinion shaft is supported at one side of the pinion in a fixed bearing which comprises a rotary bearing (preferably a roller bearing, in a particularly preferred manner a ball bearing), in which the pinion shaft is received, wherein the fixed bearing enables a pivoting of the pinion shaft about a pivot axis which is orientated perpendicularly to the rotation axis. At the other side of the pinion, the pinion shaft is additionally supported in a movable bearing which also comprises a rotary bearing (preferably a roller bearing, in a particularly preferred manner a ball bearing), in which the pinion shaft is received, wherein for the rotary bearing a movability inside the housing is ensured with respect to the pivoting movability of the pinion shaft which is guided by the fixed bearing.

In principle, however, steering gear mechanisms in which alternative bearings for the pinion shaft are provided are also suitable for preparing these steering gear mechanisms for subsequent use as part of steering systems in accordance with a method according to the invention.

Preferably, such a steering gear mechanism which is suitable for use in the context of a method according to the invention is additionally characterized in that the force, with which the pinion shaft is pressed against the gear can be adjusted in a variable manner, and therefore adjusted or maintained at different heights, by means of an adjustment device which constitutes a structural component of the steering gear mechanism and which is consequently also included during the use of the steering gear mechanism. In a steering gear mechanism according to the invention with the preferably provided bearing of the pinion shaft in a fixed bearing and a movable bearing, the adjustment device can to this end be integrated in particular in the fixed bearing and/or in the movable bearing or be a component thereof. Using such an adjustment device which is included by the steering gear mechanism, it is not only possible to carry out an adjustment of the various forces when a method according to the invention is carried out, it can also advantageously be used to adjust the second force, that is to say, the one with which the pinion shaft is pressed against the gear during operation of the steering gear mechanism, individually in the most optimum manner possible for each individual steering gear mechanism, whereby in particular production-related tolerances can be compensated for. In this instance, there may also be provision for this force to be adjusted differently or changed or by means of readjustment be kept as constant as possible over the period of use of the steering gear mechanism.

Alternatively, it is also possible when a method according to the invention is carried out for the first force to be applied by means of an assembly device which is not a component of the steering system itself, whilst the second force is adjusted as a result of the structural configuration of the steering gear mechanism when the assembly device is no longer used to influence the force with which the pinion shaft is pressed against the gear.

It is further also possible to use such an assembly device even when an adjustment device, by means of which a force with which the pinion shaft is pressed against the gear can be adjusted in a variable manner, is provided.

According to a preferred embodiment, there may be provision for the adjustment device to be integrated exclusively in the fixed bearing. To this end, the fixed bearing of a steering gear mechanism according to the invention may preferably comprise a pivot ring which has an outer ring and an inner ring which are connected to each other by means of one or more torsion webs so as to be able to be pivoted about the pivot axis defined by the torsion web(s), wherein the inner ring is received in the fixed bearing sleeve and the outer ring is supported inside the housing, in particular directly or indirectly in or on the housing.

Furthermore, the adjustment device may preferably be constructed in such a manner that using it the position of the outer ring of the pivot ring of the fixed bearing can be adjusted (that is to say, can be changed, wherein a plurality of positions can be fixed) inside the housing at least (preferably exclusively) with respect to the directions which are orientated perpendicularly to the longitudinal axis of the outer ring and perpendicularly to the pivot axis. The adjustability can in this instance be produced only once or preferably several times, in particular as often as desired. As a result of the displaceability of the outer ring of the pivot ring which is involved with the adjustability of the position of the outer ring, in combination with the support of the pinion shaft on the gear a selective influence of the torsion or the torsion webs and consequently of the force with which the pinion shaft is pressed against the gear can be produced.

According to an embodiment of such a steering gear mechanism according to the invention which is advantageous from a structural point of view, there may further be provision for the adjustment device to comprise a (first) bearing journal whose longitudinal axis is orientated perpendicularly to the longitudinal axis of the outer ring and to the pivot axis and which connects the outer ring of the pivot ring to a bearing location of the housing, wherein the bearing location comprises means for fixing the bearing pin in different positions with respect to the longitudinal axis thereof. In this instance, these means for fixing the bearing pin may in particular comprise a threaded element which has a thread which cooperates with a counter-thread of the bearing location, in particular a counter-thread which is directly integrated in the housing. As a result of a rotation of the threaded element, it is consequently displaced within the housing, wherein the movement of the threaded element is transmitted to the bearing pin and from it to the outer ring of the pivot ring. If the threaded element is not rotated, fixes the adjusted position of the outer ring within the housing.

Such a screwable adjustability of the position of the outer ring provides an advantageous way of producing a repeated adjustability which can in particular be carried out as often as desired since, on the one hand, as a result of a simple rotational movement of the threaded element, a displacement of the outer ring of the pivot ring can be produced, whilst, on the other hand, the threaded connection fixes an adjusted position of the outer ring as a result of self-locking resulting from the friction in the thread pairing when the threaded element of is not rotated. Of course, this does not exclude an adjusted position of the outer ring additionally being retained in a secure manner by additional threaded securing means, for example, an adhesively acting threaded securing means and/or a counter-threaded element, being used.

Additionally or alternatively, a fixing of a previously adjusted position of the outer ring of the pivot ring may also be brought about by other fixing means, for example, by a clamping fixing of the (first) bearing journal in the bearing location of the housing. In this instance, such a clamping of the (first) bearing journal may be releasable or non-releasable. For a releasable fixing, this may be expanded in a changeable manner, for example, by means of a screw element which can be screwed into the (first) bearing journal. For a non-releasable fixing, in contrast, there may be provision for the (first) bearing journal to be plastically deformed and in this instance expanded in order to produce a clamping fixing within the bearing location.

In order to produce the most advantageous possible support of the loading of the outer ring of the pivot ring resulting in particular from the torsion of the torsion webs, according to a preferred development of such a steering gear mechanism according to the invention there may further be provided a second bearing journal which is arranged radially or diametrically opposite the first bearing journal with respect to the longitudinal axis of the outer ring and which is supported axially with respect to the longitudinal axis thereof so as to be able to be moved in the outer ring or inside the housing, in particular directly in or on the housing. It is thereby possible to prevent the pivot loading, which acts as a counter-reaction as a result of the torsion of the torsion webs on the outer ring of the pivot ring, from having to be supported exclusively by the first bearing journal and the bearing location of the housing which cooperates therewith.

In such an embodiment of a steering gear mechanism according to the invention, the preferably cylindrical bearing journals may further be orientated coaxially with respect to the longitudinal axes thereof and/or rotatably supported with respect to the longitudinal axes thereof in the outer ring or inside the housing, in particular directly in or on the housing. As a result, a functionally advantageous pivotability of the pinion shaft about a rotation axis which is orientated perpendicularly to the pivot axis is also produced, which may have a positive effect with regard to the operational behavior of the steering gear mechanism.

According to an embodiment of a steering gear mechanism according to the invention which is advantageous from a structural point of view, there may further be provision for the outer ring of the pivot ring to have a tubular portion, on which the bearing journal(s) is/are arranged. A structurally advantageous connection of the bearing journals to the outer ring is thereby produced. In particular, there may be provision for the bearing journal(s) to be received as separate component(s) (in each case) in an opening or recess of the tubular portion. In a particularly preferred manner, the bearing journal(s) may be commercially available roller members of roller bearings since in spite of high wear resistance and low tolerances they are available in a cost-effective manner.

The bearing journals may in particular be retained inside the opening or recess of the tubular portion by means of a press-fit and/or adhesively bonded, welded or soldered.

The term “longitudinal axis” of a member or a hollow space which has a covering face which extends in a closed manner is intended to be understood to refer to the axis which connects the geometric centers of gravity of the different cross-sections of this covering face.

The invention also relates to a steering system which comprises at least one steering gear mechanism according to the invention and a steering motor which is connected to the pinion shaft in a rotationally driving manner. The gear of the steering gear mechanism may further be connected in a rotationally secure or rotationally driving manner to a steering shaft, in particular a steering column, of the steering system. The steering system according to the invention may in particular be constructed as a power-assisted steering system, by means of which a supporting torque can be produced using the steering motor so that a steering torque which has to be applied to the steering column by a driver of a motor vehicle which comprises the power-assisted steering system for steering the motor vehicle is reduced (where applicable, temporarily even up to zero). Alternatively, it is also possible for the steering system to be constructed in such a manner that the entire torque which is required for steering is (always) produced by the steering motor.

The invention further relates to a motor vehicle having a steering system according to the invention.

The indefinite articles (“a”, “an”, “of a” and “of an”), in particular in the patent claims and in the description which generally explains the patent claims, are intended to be understood per se and not as numerals. Components which are accordingly thereby specified are consequently intended to be understood in such a manner that they are present at least once and may be present several times.

The invention is explained in greater detail below with reference to an embodiment of a steering gear mechanism according to the invention as illustrated in the drawings, in which:

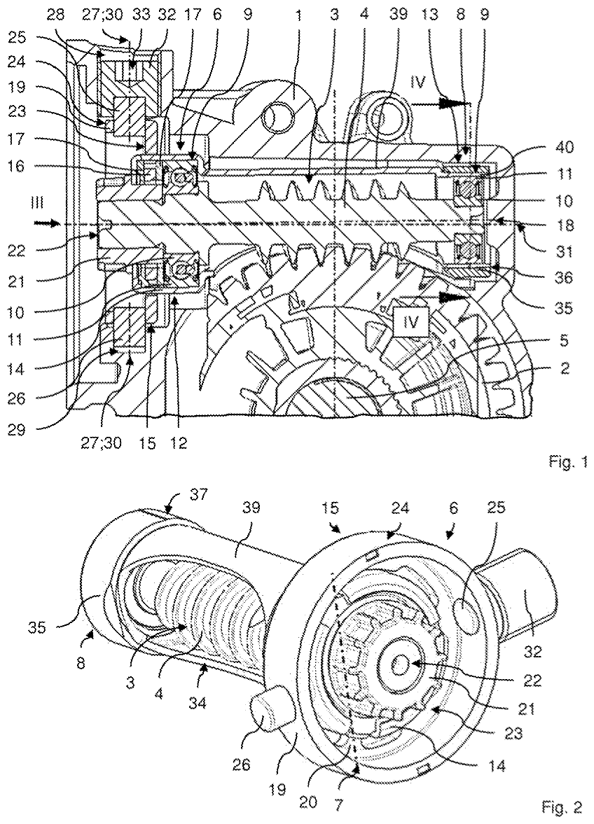

FIG. 1: is a longitudinal section through the steering gear mechanism;

FIG. 2: is a perspective view of a bearing device of a fixed bearing and a movable bearing and a pinion shaft the steering gear mechanism;

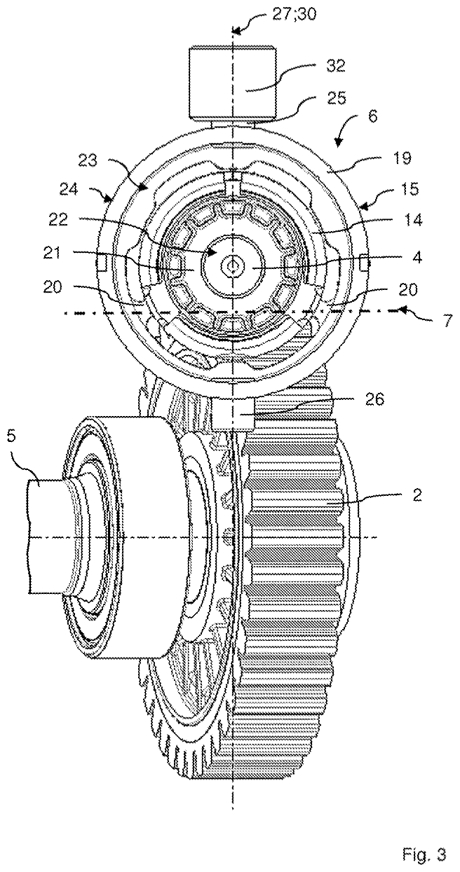

FIG. 3: is a view of the steering gear mechanism without the associated housing in the viewing direction III in FIG. 1; and

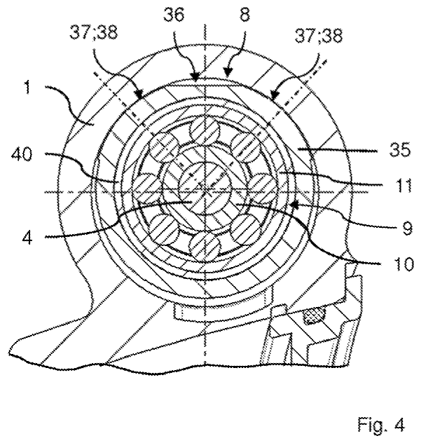

FIG. 4: is a cross-sect ion through the steering gear mechanism along the plane of section IV-IV in FIG. 1.

FIG. 1 shows the significant components of a steering gear mechanism according to the invention. It comprises a housing 1, inside which a gear 2 and a pinion 3 which meshes with the gear 2 and which is in the form of a helical pinion are rotatably arranged. The pinion 3 and a (helical) pinion shaft 4 which comprises the pinion 3 are constructed integrally the form of a worm. At least a portion forming the teeth of the gear 2 comprises plastics material. However, the pinion 3 or the entire pinion shaft 4 is preferably constructed from metal and in particular steel.

The gear 2 is securely fixed to an output shaft 5 of the steering gear mechanism. This output shaft 5 which in the embodiment shown has a tooth arrangement for a secure, rotationally fixed connection to the gear 2 may, for example, mesh with a steering rod which is formed in at least one portion as a toothed rack, whereby the toothed rack carries out a translational movement which in known manner can be converted by means of wheel steering levers (not illustrated) into a pivot movement of steerable wheels (not illustrated) of the motor vehicle. The output shaft 5 may, however, also be a steering column of a power-assisted steering system which is connected to a steering wheel and which acts via a steering pinion on the steering rod.

The pinion shaft 4 has a drive-side end, via which it can be connected in a rotationally secure manner to the output shaft of a steering motor (not illustrated; for example, an electric or hydraulic motor). In the region of this drive-side end, the pinion shaft 4 is supported by means of a first bearing in the housing 1. This bearing is constructed as a fixed bearing 6, which permits a pivoting of the pinion shaft 4 about a pivot axis 7 (cf. FIGS. 2 and 3). This pivot axis 7 extends in this instance in FIG. 1 perpendicularly to the drawing plane. Such a pivoting brings about a deflection of the end of the pinion shaft 4 opposite the drive-side end, which pinion shaft 4 is supported at that location by means of a movable bearing 8 within the housing 1. This movable bearing 8 is constructed in such a manner that it permits the deflection of this end of the pinion shaft 4, as results from the pivoting of the pinion shaft 4.

Both the fixed bearing 6 and the movable bearing 8 each comprise a rotary bearing 9 in the form of a ball bearing.

The corresponding portions of the pinion shaft 4 are supported in inner bearing rings 10 of these rotary bearings 9, whilst external bearing rings 11 of the rotary bearings 9 are supported in a bearing device 12, 13 in each case which are in turn received within the housing 1. The bearing devices 12, 13 are structurally constructed in such a manner that they permit in the case of the fixed bearing 6, inter alia, the pivoting of the pinion shaft 4 about the pivot axis 7 and in the case of the movable bearing 8 the deflection of the free end of the pinion shaft 4.

To this end, the bearing device 12 of the fixed bearing 6 comprises a fixed bearing sleeve 14 with circular-ring-like cross-sections which receives at the inner side in a first longitudinal portion the associated rotary bearing 9 and in a second longitudinal portion an inner ring 16 of a pivot ring 15. This inner ring 16 of the pivot ring 15 and the outer bearing ring 11 of the rotary bearing 9 of the fixed bearing 6 are supported so as to be axially

secured within the fixed bearing sleeve 14 with two annular disks 17 being interposed, wherein the inner ring 16 of the pivot ring 15 is supported, with the annular disks 17 being interposed, on the one hand, on the outer bearing ring 11 of the rotary bearing 9 and, on the other hand, on a first peripheral shoulder which is formed by the fixed bearing sleeve 14 at an axial end. In the same manner, the side of the outer bearing ring 11 of the rotary bearing 9, which side is distally located from the inner ring 16 of the pivot ring 15, is supported on a second, peripheral shoulder which is formed by the fixed bearing sleeve 14 at the other axial end.

The pivot ring 15 also comprises in addition to the inner ring 16 an outer ring 19. This outer ring 19 is connected to the inner ring 16 by means of two torsion webs 20 (cf. FIGS. 2 and 3). The outer ring 19, the inner ring 16 and the torsion webs 20 are constructed integrally, for example, from spring steel.

The two torsion webs 20 define the position of the pivot axis 7, about which the outer ring 19 can be pivoted relative to the inner ring 16 of the pivot ring 15. The torsion webs 20 of the pivot ring 15 enable in this instance not only a pivoting of the outer ring 19 relative to the inner ring 16 and consequently of the pinion shaft 4 relative to the gear 2 or the housing 1, but also bring about at the same time the resilient force by means of which the pinion 3 is pressed into the tooth arrangement of the gear 2 in order to achieve the smallest possible gear play and consequently the smallest possible generation of noise during operation of the steering gear mechanism, in particular during alternating steering. This resilient force results from the fact that, during the assembly of the steering gear mechanism, the pinion shaft 4 is deflected as a result of contact with the gear 2 to such an extent that sufficient twisting (torsion) of the torsion webs 20 is produced, whereby the resilient restoring torques which result from this torsion of the torsion webs 20 counteract the deflection of the pinion shaft 4 and consequently press it against the gear 2.

An axial position fixing of the inner bearing ring 10 of the rotary bearing 9 of the fixed bearing 6 on the pinion shaft 4 and the components which are arranged within the fixed bearing sleeve 14 is carried out with there being interposed a pressure piece 21 which is in abutment with the inner bearing ring 10 and which is screwed to a threaded portion 22 at the drive-side end of the pinion shaft 4.

The outer ring 19 of the pivot ring 15 is constructed in a pot-like manner and accordingly comprises a radially extending portion 23 and an axially extending tubular portion 24 with circular-ring-like cross-sections. The tubular portion 24 extends, in this instance from the side of the radially extending portion 23 of the outer ring 19 of the pivot ring 15, which side faces away from the rotary bearing 9. In the region of the tubular portion 24, the wall of the outer ring 19 of the pivot ring 15 forms two radially or diametrically opposing through-openings, in which a cylindrical bearing journal 25, 26 is received in a fixed manner. The bearing journals 25, 26 whose longitudinal axes 27 are orientated coaxially with respect to each other protrude in this instance over the outer side of the wall of the outer ring 19 of the pivot ring 15. The bearing journals 25, 26 protrude with these portions, into bearing receiving members 28, 29 of the housing 1 in order to ensure, on the one hand, a relatability of the bearing device 12 with respect to a rotation axis 30 which is orientated perpendicularly, on the one hand, to the longitudinal axis 31 of the outer ring 19 and, on the other hand, the pivot axis 7. On the other hand, these bearing journals 25, 26 are components of an adjustment device of the steering gear mechanism, by means of which the position of the outer ring 19 of the pivot ring 15 can be adjusted within the housing 1 with respect to the directions which correspond to this rotation axis 30.

The fixing of the bearing journals 25, 26 within the through-openings of the wall of the outer ring 19 of the pivot ring 15 is selected to be non-releasable and may in particular be carried out in a materially engaging manner, for example, by means of welding, soldering or adhesive bonding. Non-positive-locking (for example, by means of a press-fit) and positive-locking connection (for example, by means of a screw connection), then where applicable also releasable connection variants are also possible.

The adjustment device further comprises in addition to the two bearing journals 25, 26 a threaded element 32, which forms an outer thread which cooperates with an inner thread of a first (28) of the bearing receiving members of the housing 1. At the end face facing the outer side of the housing 1, the threaded element 32 forms a recess 33 which is hexagonal in cross-section and in which there can be inserted a corresponding tool (not illustrated) by means of which a torque can be transmitted to the threaded element 32, whereby the threaded element 32, as a result of a cooperation of the outer thread thereof with the inner thread (counter-thread) of the first bearing receiving member 28 can be moved along the longitudinal axis 27 of the first bearing receiving member 28 which extends coaxially relative to the longitudinal axes 27 of the bearing journals 25, 26. At the end face facing the inner side of the housing 1, the threaded element 32 also forms a recess which is cylindrical or circular in cross-section and in which an end portion of a first (25) of the bearing journals engages in a play-free manner to the greatest possible extent.

If the threaded element 32, when viewed from the outer side of the housing 1, is screwed further into the bearing receiving member 28, this movement of the threaded element 32 is transmitted to the first bearing journal 25 and from there to the outer ring 19 of the pivot ring 15 and to the second bearing journal 26 which in this instance is displaced in a longitudinally axial manner in the second bearing receiving member 29 of the housing 1 which is also constructed in a cylindrical manner and with an only slightly larger diameter in comparison with the diameter of the second bearing journal 26.

The displacement of the outer ring 19 and consequently of the pivot ring 15 brought about by such a screwing-in action of the threaded element 32 into the first bearing receiving member 28 leads as a result of the support of the pinion 3 on the gear 2 to a pivoting of the pinion shaft 4. This pivoting of the pinion shaft 4 and of the connected inner ring 16 of the pivot ring leads at the same time to an increasing torsion of the torsion webs 20 since the outer ring 19 of the pivot ring 15 cannot follow this pivot movement of the inner ring 16 since the bearing of the bearing pins 25, 26 in the bearing receiving members 28, 29 of the housing 1 does not permit such a pivot movement of the outer ring 19.

If, however, the threaded element 32 is unscrewed to a small extent from the first bearing receiving member 28, the resilient application of the pinion shaft 4 results in the outer ring 19 with the two bearing pins 25, 26 following the movement of the threaded element 32, whereby the torsion of the torsion webs 20 and consequently the resilient application of the pinion shaft 4 is reduced. Accordingly, as a result of a change of the position of the outer ring 19 of the pivot ring 15 within the housing 1 with respect to the directions mentioned, the resilient application of the pinion shaft 4 or the force with which the pinion shaft 4 is pressed against the gear 2 can be adjusted.

The bearing device 13 of the movable bearing 8 comprises a stop element in the form of a stop sleeve 35 which is arranged to be able to be moved within a receiving space 36 formed by the housing 1 in such a manner that, within the limits of a structurally defined basic play, the pivoting movability about the pivot axis 7 defined or formed by the fixed bearing 6 is possible. In this instance, this movability is limited in one direction by a contact which is complete or which occurs on two flanks of the individual teeth of the pinion 3 and gear 2 and which is brought about by the resilient loading by means of the twisted torsion webs 20 and, in the other direction, by a stop which is brought about by means of a contact of contact faces 37, 38 which are formed, on the one hand, by the stop sleeve 35 and, on the other hand, by the wall of the housing 1 which delimits the receiving space 36 (cf. FIG. 4).

Details relating to the structure and operation of the movable bearing 8 can be derived from the previously unpublished German patent application 10 2017 211 461.4.

The steering gear mechanism further comprises a connection element 39 which connects the fixed bearing sleeve 14 to a movable bearing sleeve 40 of the movable bearing 8 and to this end is constructed in an integral and materially uniform manner with the bearing sleeves 14, 40. As can be seen in FIGS. 1 and 2, the connection element 39 is constructed in a tubular manner with circular-ring-like or partially circular-ring-like cross-sections, wherein it has a covering opening 34 which is arranged in a central portion of the connection element 39 and which extends over a portion of the periphery thereof. As a result of this covering opening 34, a portion of the gear 2 may protrude into the inner space which is delimited by the connection element 39 and which receives the pinion shaft 4 in the portion which inter alia forms the pinion 3 in order to allow an engagement of the tooth arrangements of the gear 2 and the pinion 3.

The connection element 39 results, on the one hand, in the resilient restoring torques which result from the torsion of the torsion webs 20 of the pivot ring 15 of the fixed bearing 6 not being transmitted exclusively via the rotary bearing 9 of the fixed bearing 6 to the pinion shaft 4, which would be linked with a relatively high tilting loading of this rotary bearing 9. Instead, these resilient restoring torques are transmitted primarily via the fixed bearing sleeve 14 of the fixed bearing 6 and the integrally connected connection element 39 and via the movable bearing sleeve 40 to the rotary bearing 9 of the movable bearing 8. On the other hand, as a result of the connection element 37, a relative rotation between the fixed bearing sleeve 14 and the movable bearing sleeve 40 about the longitudinal axes 18 thereof is prevented.

The steering gear mechanism, as a result of the integration of the adjustment device into the fixed bearing 6, is advantageously suitable for carrying out a method according to the invention, whereby it is intended to be prepared for a subsequent use as part of a steering system of a motor vehicle.

To this end, the threaded element 32 of the adjustment device is first screwed to a relatively large extent into the first bearing receiving member 28 of the housing 1, which results in a correspondingly significant torsion of the torsion webs 20, which in turn leads to a correspondingly high (first) force, by means of which the pinion shaft 4 or the pinion 3 is pressed against the gear 2.

Subsequently, the pinion shaft 4 is rotatingly driven by means of a rotary drive which may be the steering motor which is provided as part of the steering system or a rotary drive (not illustrated) which is provided only for carrying out the method, firstly in a first of the two possible rotation directions and subsequently in the other of these rotation directions. This is carried out in each case at least until the gear 2 has carried out at least one complete revolution, where applicable a large number of revolutions. The correspondingly high surface pressure which is applied as a result of the relatively large first force in the tooth engagement between the pinion 3 and the gear 2 leads to a plastic deformation or the plastics material of the gear 2 which results in a globoid tooth arrangement of this gear 2. Tolerance-related deviations from the structurally provided tooth engagement are thereby compensated for and a settlement of the plastics material of the gear 2, which would otherwise only occur in the context of the operation of the steering gear mechanism as part of the steering system, is brought about.

Subsequently, the threaded element 32 is again unscrewed from the first bearing receiving member 28 of the housing 1 to such an extent and consequently the force with which the pinion shaft 4 or the pinion 3 is pressed against the gear 2 is reduced until (when a second value for this force is reached) for the individual steering gear mechanism the most optimum possible compromise between, on the one hand, a sufficiently large resilient application of the pinion shaft 4 and, on the other hand, a not excessively high friction in the tooth engagement is achieved. The sufficiently large resilient application ensures only a low generation of noise during operation of the steering gear mechanism, whilst, as a result of the relatively low friction in the tooth engagement, an advantageous steering sensation and a relatively low wear of the sets of teeth of the pinion 3 and gear 2 over the intended service-life of the steering gear mechanism is achieved. The steering gear mechanism can then advantageously be used with this adjustment of the threaded element 32 as a part of a steering system of a motor vehicle.

### LIST OF REFERENCE NUMERALS

1 Housing

2 Gear

3 (Helical) pinion

4 (Helical) pinion shaft

5 Output shaft

6 Fixed bearing

7 Pivot axis

8 Movable bearing,

9 Rotary bearing

10 Inner bearing ring of a rotary bearing

11 Outer bearing ring of a rotary bearing

12 Bearing device of the fixed bearing

13 Bearing device of the movable bearing

14 Fixed bearing sleeve

15 Pivot ring

16 Inner ring of the pivot ring

17 Annular disk

18 Longitudinal axes of the fixed bearing sleeve/movable bearing sleeve/pinion shaft

19 Outer ring of the pivot ring

20 Torsion web

21 Pressure piece

22 Threaded portion of the pinion shaft

23 Radially extending portion of the outer ring

24 Axially extending portion of the outer ring

25 First bearing journal

26 Second bearing journal

27 Longitudinal axis of a bearing journal/a bearing receiving member

28 First bearing receiving member of the housing

29 Second bearing receiving member of the housing

30 Rotation axis

31 Longitudinal axis of the outer ring

32 Threaded element

33 Recess of the threaded element

34 Covering opening of the connection element

35 Stop sleeve

36 Receiving space of the housing

37 Contact face of the stop sleeve

38 Contact face of the housing

39 Connection element

40 Movable bearing sleeve

1. A method for preparing a steering gear mechanism for subsequent use as part of a steering system of a motor vehicle, wherein the steering gear mechanism has (i) a gear having gear teeth, and (ii) a pinion having pinion teeth which meshes with the gear teeth, and wherein at least the gear and/or the pinion teeth are formed from plastics material, comprising:
(a) pressing the pinion with a first force against the gear;
(b) during step (a), rotating the pinion and the gear in a first rotation direction and subsequently in a second rotation direction; and
(c) after step (b), pressing the pinion with a second force which is smaller than the first force against the gear, wherein this second force is permanently adjusted.

2. The method as claimed in claim 1, wherein the first force is selected to be so high that a plastic deformation of the plastics material of the gear and/or of the pinion is achieved.

3. The method as claimed in claim 1, wherein step (b) includes rotating the pinion and the gear in the first rotation direction and/or in the second rotation direction until the gear has carried out at least one complete revolution.

4. The method as claimed in claim 1, wherein step (a) further includes subjecting the gear and/or the pinion at least temporarily to an atmosphere which differs from ambient atmosphere.

5. The method as claimed in claim 1, wherein step (a) further includes introducing a contact mechanism into the tooth engagement of the pinion and gear at least during step (a) so as to influence friction in the tooth engagement.

6. (canceled)

7. A steering gear mechanism for a steering system of a motor vehicle, comprising:
a housing,
a gear having gear teeth,
a pinion shaft including a pinion having pinion teeth which meshes with the gear teeth,
wherein at least the gear teeth and/or the pinion teeth are formed from plastics material
wherein the pinion shaft is supported at one side of the pinion in a fixed bearing which comprises a rotary bearing in which the pinion shaft is received,
wherein the fixed bearing enables a pivoting of the pinion shaft about a pivot axis which is orientated perpendicularly to the rotation axis and at the other side of the pinion is supported in a movable bearing which comprises a rotary bearing, in which the pinion shaft is received,
wherein for the rotary bearing a movability within the housing with regard to the pivoting movability of the pinion shaft which is guided by the fixed bearing is ensured, and
wherein an adjustment device which is integrated in the fixed bearing and/or in the movable bearing and by way of which a force with which the pinion shaft is pressed against the gear can be adjusted in a variable manner.

8. The steering gear mechanism as claimed in claim 7, wherein:
the rotary bearing of the fixed bearing is received in a fixed bearing sleeve and the fixed bearing further comprises a pivot ring which has an outer ring and an inner ring which are connected to each other by way of one or more torsion webs so as to be able to be pivoted about the pivot axis defined by the one or more torsion webs,
the inner ring is received in the fixed bearing sleeve and the outer ring is supported inside the housing, and
the adjustment device is further constructed in such a manner that using it the position of the outer ring of the pivot ring can be adjusted inside the housing with respect to the directions which are orientated perpendicularly to the longitudinal axis of the outer ring and perpendicularly to the pivot axis.

9. The steering gear mechanism as claimed in claim 8, wherein:
the adjustment device comprises a first bearing journal whose longitudinal axis is orientated perpendicularly to the longitudinal axis of the outer ring and to the pivot axis and which connects the outer ring of the pivot ring to a bearing location of the housing, and
the bearing location comprises means for fixing the first bearing journal in different positions with respect to the longitudinal axis thereof.

10. The steering gear mechanism as claimed in claim 9, wherein the means for fixing the first bearing journal comprises a threaded element which has a thread which cooperates with a counter-thread of the bearing location.

11. The steering gear mechanism as claimed in claim 9, further comprising:
a second bearing journal which is arranged radially opposite the first bearing journal with respect to the longitudinal axis of the outer ring and which is supported along the longitudinal axis thereof so as to be able to be moved in the outer ring or in the housing.

12. The steering gear mechanism as claimed in claim 11, wherein the bearing journals are orientated coaxially relative to each other with respect to the longitudinal axes thereof.

13. The steering gear mechanism as claimed in claim 10, wherein the bearing journals are rotatably supported about the longitudinal axes thereof in the outer ring or in the housing.

14. The steering gear mechanism as claimed in claim 9, wherein the outer ring of the pivot ring has a tubular portion, on which the bearing journals are arranged.

15. The steering gear mechanism as claimed in claim 14, wherein the bearing journals are received as separate components in an opening or recess of the tubular portion.
